(19) United States
(12) Patent Application Publication
(10) Pub. No.: US 2024/0330134 A1
(43) Pub. Date: Oct. 3, 2024

(54) Boot-Up and Memory Testing with Chipset Attached Memory

(71) Applicant: Advanced Micro Devices, Inc., Santa Clara, CA (US)

(72) Inventors: Jerry Anton Ahrens, Sister Bay, WI (US); William Robert Alverson, Del Valle, TX (US); Joshua Taylor Knight, Georgetown, TX (US); Amitabh Mehra, Fort Collins, CO (US); Anil Harwani, Austin, TX (US); Grant Evan Ley, Eden, UT (US)

(73) Assignee: Advanced Micro Devices, Inc., Santa Clara, CA (US)

(21) Appl. No.: 18/190,664

(22) Filed: Mar. 27, 2023

(51) Int. Cl. G06F 11/22; G06F 9/4401

(52) U.S. Cl. CPC G06F 11/2284; G06F 9/4401

(57) ABSTRACT

A system that includes at least a system memory, a chipset link, and a chipset attached memory is powered down. A boot-up process is loaded in the chipset attached memory. The boot-up process is performed for the system, via the chipset link, by the chipset attached memory. The boot-up process includes loading one or more memory testing applications. The system memory is tested using the one or more memory testing applications loaded by the chipset attached memory.

### BACKGROUND

Computer games and other applications are regularly advancing, resulting in larger programs, higher resolution graphics, new features, and so forth. To address these advances, computer hardware is also advancing to provide new types of memory having faster data rates, faster clock rates, and so forth.

### BRIEF DESCRIPTION OF THE DRAWINGS

FIG. 1 is an illustration of a non-limiting example system that is operable to boot up from a chipset attached memory to test a system memory.

FIG. 2 depicts a non-limiting example in which a system is booted up from a chipset attached memory to test a system memory.

FIG. 3 depicts a procedure in an example implementation of boot-up and memory testing with chipset attached memory.

FIG. 4 is an illustration of another non-limiting example system that employs a chipset attached memory for boot-up and testing a system memory.

FIG. 5 is an illustration of another non-limiting example system that employs a chipset attached memory for boot-up and testing a system memory.

### DETAILED DESCRIPTION

### Overview

In conventional approaches, systems are booted up from main memory, e.g., their system memory. However, when there are bugs and/or problems with the system memory, such as during development of a new system memory and/or as system memory ages (or experiences some event), those bugs and/or problems can prevent the system from initializing completely. By way of example, a properly operating system memory is “critical” for many initialization operations, i.e., those operations cannot be performed without a properly operating system memory. Further, various tools (e.g., debugging and/or testing applications) are configured to operate only after such initialization operations involving the system memory are completed. Such “tools” include applications which enable easier troubleshooting of problems and/or bugs with the system memory. Since conventional approaches, which boot-up from the system memory, can fail to completely initialize, applications for easy debugging of system memory cannot be reliably used with conventional systems. As a result, system memory troubleshooting with conventional systems can be an arduous process—that can involve guessing at problems with the memory-preventing system memory from proper operation for a longer time than the described techniques.

Boot-up and memory testing with a chipset attached memory is described. In contrast to conventional approaches, the described system and techniques are operable to boot-up a system from a chipset attached memory. In one or more implementations, a boot-up process is accessed from the chipset attached memory, e.g., by a chipset attached memory controller. In at least one variation, the boot-up process is accessed from the chipset attached memory to boot-up the system, which includes, for instance, initializing one or more hardware components (e.g., a processing unit), loading an operating system (e.g., on the processing unit), and loading one or more applications (e.g., on the processing unit). In other words, the boot-up process is accessed from the chipset attached memory to return the system to a working state (e.g., G0/S0 state as specified by Advanced Configuration and Power Interface (ACPI)).

In accordance with the described techniques, booting up the system using the boot-up process from the chipset attached memory enables applications to be loaded (e.g., into the processing unit) for debugging, testing, and logging problems with the system memory. By way of example, a memory testing application can be loaded to perform one or more tests on the system memory and to report results of those tests, e.g., by presenting them via a user interface and/or incorporating them into a file. In at least one variation, one or more of the memory testing applications are executed by the processing unit and using the chipset attached memory, e.g., as the main memory. This allows the system memory to be directly tested while the system operates from the chipset attached memory. As a result, the chipset attached memory enables the system memory to be tested by a system which is not reliant on the system memory to operate properly. Instead, the system relies on the chipset attached memory for proper operation while testing the system memory.

In some aspects, the techniques described herein relate to an apparatus including: a system memory, a chipset attached memory, and a memory controller configured to: power down the apparatus, and load a boot-up process in the chipset attached memory, the boot-up process configured to perform the boot-up process for the apparatus by the chipset attached memory.

In some aspects, the techniques described herein relate to an apparatus, wherein the boot-up process loads one or more memory testing applications.

In some aspects, the techniques described herein relate to an apparatus, wherein the one or more memory testing applications are configured to test the system memory.

In some aspects, the techniques described herein relate to an apparatus, wherein the one or more memory testing applications are further configured to report results of the testing by presenting the results of the testing on a user interface or incorporating the results of the testing into a file.

In some aspects, the techniques described herein relate to an apparatus, wherein the boot-up process is further configured to initialize one or more hardware components of the apparatus.

In some aspects, the techniques described herein relate to an apparatus, wherein the boot-up process is further configured to load an operating system.

In some aspects, the techniques described herein relate to an apparatus, wherein the system memory includes a main physical memory of the apparatus that is managed by an operating system.

In some aspects, the techniques described herein relate to an apparatus, wherein the chipset attached memory is separate from the system memory.

In some aspects, the techniques described herein relate to an apparatus, wherein the memory controller loads the boot-up process in the chipset attached memory when the apparatus is in a bypass mode, the bypass mode configured to bypass the system memory.

In some aspects, the techniques described herein relate to an apparatus, wherein the memory controller is further configured to switch to a non-bypass mode after the boot-up process is complete, the non-bypass mode configured to use the system memory as a main memory.

In some aspects, the techniques described herein relate to a method including: powering down a system that includes at least a system memory, a chipset link, and a chipset attached memory, loading a boot-up process in the chipset attached memory, performing the boot-up process for the system, via the chipset link, by the chipset attached memory, the boot-up process including loading one or more memory testing applications, and testing the system memory using the one or more memory testing applications loaded by the chipset attached memory.

In some aspects, the techniques described herein relate to a method, wherein the system memory includes a main physical memory that is managed by an operating system of the system.

In some aspects, the techniques described herein relate to a method, wherein the chipset attached memory is separate from the main physical memory.

In some aspects, the techniques described herein relate to a method, wherein the one or more memory testing applications are configured to report results of the testing by presenting the results of the testing on a user interface or incorporating the results of the testing into a file.

In some aspects, the techniques described herein relate to a method, wherein the boot-up process is further configured to initialize one or more hardware components of the system.

In some aspects, the techniques described herein relate to a method, wherein the boot-up process is further configured to load an operating system.

In some aspects, the techniques described herein relate to a method, wherein the boot-up process is loaded in the chipset attached memory when the system is in a bypass mode, the bypass mode configured to bypass the system memory.

In some aspects, the techniques described herein relate to a method, further including switching to a non-bypass mode after the boot-up process is complete, the non-bypass mode configured to use the system memory as a main memory.

In some aspects, the techniques described herein relate to a system including: a system memory, and a chipset attached memory configured to load a boot-up process when the system memory is in a bypass mode, the boot-up process configured to test the system memory in the bypass mode.

In some aspects, the techniques described herein relate to a system, wherein the system memory including a main system memory and wherein the chipset attached memory is separate from the main system memory.

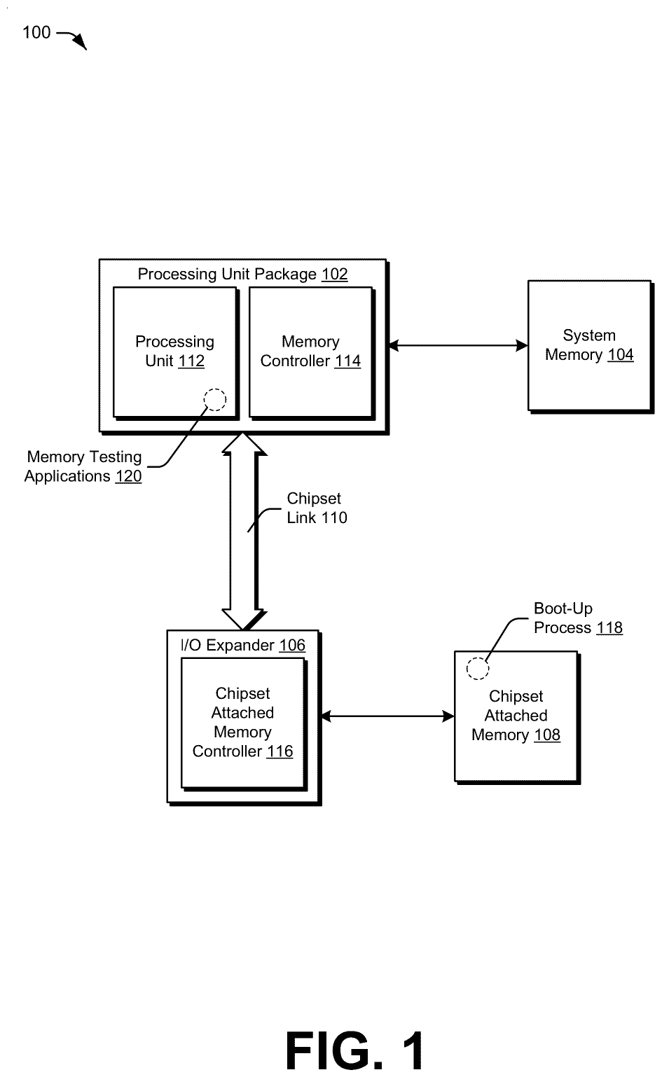

FIG. 1 is an illustration of a non-limiting example system 100 that is operable to boot up from a chipset attached memory to test a system memory. The system 100 includes a processing unit package 102, a system memory 104, an I/O expander 106, a chipset attached memory 108, and a chipset link 110. The processing unit package 102, the system memory 104, the I/O expander 106, the chipset attached memory 108, and the chipset link 110 are installed on or are part of, for example, a motherboard or other printed circuit board. In one or more implementations, the I/O expander 106 (including the chipset attached memory controller 116), the chipset link 110, one or more memory channels between the processing unit package 102 and the system memory 104, and one or more memory channels between the I/O expander 106 and the chipset attached memory 108 are also referred to as a chipset of a motherboard or other printed circuit board. In one or more variations, the chipset link 110 is routed entirely on the motherboard itself. In one or more other variations, the I/O expander 106 (including the chipset attached memory controller 116) and the chipset attached memory 108 are implemented on an add-in card that is connected to the motherboard via one or more sockets. In one or more implementations, one or more of the I/O expander 106, the chipset attached memory controller 116, and/or the chipset attached memory 108 are configured to be removed and reattached to the system 100 (e.g., “plug and play”), such as via an interface which supports such removal and reattachment. At least one example of such an interface is a universal serial bus (USB) connection.

The processing unit package 102 includes a processing unit 112 and a memory controller 114. The processing unit 112 is any of various processing units, such as a central processing unit (CPU), a graphics processing unit (GPU), an Accelerated Processing Unit (APU), a parallel accelerated processor, a digital signal processor, an artificial intelligence (AI) or machine learning accelerator, and so forth. Although a single processing unit 112 is illustrated in the system 100, the processing unit package 102 optionally includes any number of processing units of the same or different types.

The system memory 104 is any of a variety of types of physical RAM. Examples of system memory 104 include dynamic random-access memory (DRAM), phase-change memory (PCM), memristors, static random-access memory (SRAM), and so forth. The system memory 104 is coupled or attached to the processing unit package 102 via one or more memory channels. The system memory 104 is packaged or configured in any of a variety of different manners. Examples of such packaging or configuring include a dual in-line memory module (DIMM), a small outline DIMM (SO-DIMM), a registered DIMM (RDIMM), a non-volatile DIMM (NVDIMM), a ball grid array (BGA) memory permanently attached to (e.g., soldered to) the motherboard (or other printed circuit board), and so forth.

Examples of types of DIMMs include, but are not limited to, synchronous dynamic random-access memory (SDRAM), double data rate (DDR) SDRAM, double data rate 2 (DDR2) SDRAM, double data rate 3 (DDR3) SDRAM, double data rate 4 (DDR4) SDRAM, and double data rate 5 (DDR5) SDRAM. In at least one variation, the system memory 104 is configured as or includes a SO-DIMM or an RDIMM according to one of the above-mentioned standards, e.g., DDR, DDR2, DDR3, DDR4, and DDR5.

Further examples of memory configurations include low-power double data rate (LPDDR), also known as LPDDR SDRAM, which is a type of synchronous dynamic random-access memory. In variations, LPDDR consumes less power than other types of memory and/or has a form factor suitable for mobile computers and devices, such as mobile phones. Examples of LPDDR include, but are not limited to, low-power double data rate 2 (LPDDR2), low-power double data rate 3 (LPDDR3), low-power double data rate 4 (LPDDR4), and low-power double data rate 5 (LPDDR5). It is to be appreciated that the system memory 104 is configurable in a variety of ways without departing from the spirit or scope of the described techniques.

The memory controller 114 manages access to the system memory 104, such as by sending read and write requests to the system memory 104 and receiving responses from the system memory 104. In one or more implementations, the system memory 104 is the main physical memory of an apparatus that is managed by an operating system running on the processing unit 112 (e.g., a CPU) of the apparatus, such as by allocating portions of the system memory 104 to applications running on the processing unit 112, managing virtual memory spaces and memory pages for applications running on the processing unit 112, and so forth.

The processing unit package 102 optionally includes one or more additional controllers to link to additional devices, such as a Peripheral Component Interconnect Express (PCIe) controller, a Serial Advanced Technology Attachment (SATA) controller, a Universal Serial Bus (USB) controller, a Serial Peripheral Interface (SPI) controller, a Low Pin Count (LPC) controller, and so forth. Additionally or alternatively, one or more of these additional controllers is implemented separate from the processing unit package 102, such as in a chip (e.g., an integrated circuit optionally referred to as a northbridge) that is part of the chipset of a motherboard or other printed circuit board.

The processing unit package 102 communicates with the I/O expander 106 via the chipset link 110. The chipset link 110 is any of a variety of communication links, such as a high-speed bus. In one example, the chipset link 110 is one or more PCIe lanes.

The I/O expander 106 includes a chipset attached memory controller 116. The I/O expander 106 optionally includes or is coupled to one or more additional controllers to link to other devices, such as a PCIe controller, a SATA controller, a USB controller, an SPI controller, an LPC controller, and so forth. In one or more implementations, the I/O expander 106 is referred to as a southbridge.

The chipset attached memory controller 116 manages access to the chipset attached memory 108, such as by sending read and write requests to the chipset attached memory 108 and receiving responses from the chipset attached memory 108. The chipset attached memory 108 is referred to as “chipset attached” due to the chipset attached memory 108 being attached to the I/O expander 106 rather than the processing unit package 102 directly, and due to the chipset attached memory 108 being controlled by a memory controller of the I/O expander 106 rather than a memory controller of the processing unit package 102. The chipset attached memory 108 is coupled or attached to the I/O expander 106 via one or more memory channels.

The chipset attached memory 108 is physical memory managed by an application or program other than an operating system running on the processing unit 112. The chipset attached memory 108 is separate from the system memory 104, allowing the chipset attached memory to be used in various manners, such as to speed up access to frequently used data, without reducing the amount of system memory 104 available to an operating system running on the processing unit 112.

The chipset attached memory 108 is any of a variety of types of physical memory. Examples of chipset attached memory 108 include random-access memory (RAM), such as DRAM, PCM, memristors, SRAM, and so forth. The chipset attached memory 108 is volatile memory or nonvolatile memory. The chipset attached memory 108 is packaged or configured in any of a variety of different manners. Examples of such packaging or configuring include a DIMM, a SO-DIMM, an RDIMM, an NVDIMM, a BGA, a 3-dimensional (3D) stacked memory, on-package memory (e.g., memory included in the I/O expander 106), memory permanently attached to (e.g., soldered to) the motherboard, and so forth.

As noted above, examples of types of DIMMs include, but are not limited to, SDRAM, DDR SDRAM, DDR2 SDRAM, DDR3 SDRAM, DDR4 SDRAM, and DDR5 SDRAM. In at least one variation, the chipset attached memory 108 is configured as or includes a SO-DIMM or an RDIMM according to one of the above-mentioned standards, e.g., DDR, DDR2, DDR3, DDR4, and DDR5. Further examples of chipset attached memory configurations include LPDDR, such as LPDDR2, LPDDR3, LPDDR4, and LPDDR5. It is to be appreciated that the chipset attached memory 108 is configurable in a variety of ways without departing from the spirit or scope of the described techniques.

In accordance with the described techniques, the system 100 enables the system memory 104 and one or more interfaces associated with the system memory 104 to be tested and/or debugged. To do so, the system 100 bypasses the system memory 104 and operates the chipset attached memory 108 as the main memory. In other words, rather than relying on the system memory 104 as the main memory, the system 100 at least temporarily relies on the chipset attached memory 108 to operate as the main memory. In one or more variations, this includes booting up the system from the chipset attached memory 108 rather than from the system memory 104 and/or loading debug and/or logging applications (e.g., for execution by the processing unit 112) by using the chipset attached memory 108 rather than the system memory 104.

In conventional approaches, systems are booted up from main memory, e.g., their system memory. However, when there are bugs and/or problems with the system memory, such as during development of a new system memory and/or as system memory ages (or experiences some event), those bugs and/or problems can prevent the system from initializing completely. By way of example, a properly operating system memory is “critical” for many initialization operations, i.e., those operations cannot be performed without a properly operating system memory. Further, various tools (e.g., debugging and/or testing applications) are configured to operate only after such initialization operations involving the system memory are completed. Such “tools” include applications which enable easier troubleshooting of problems and/or bugs with the system memory. Since conventional approaches, which boot-up from the system memory, can fail to completely initialize, applications for easy debugging of system memory cannot be reliably used with conventional systems. As a result, system memory troubleshooting with conventional systems can be an arduous process—that can involve guessing at problems with the memory-preventing system memory from proper operation for a longer time than the described techniques.

In contrast to conventional approaches, the system 100 is operable to boot-up from the chipset attached memory 108. In this example, the chipset attached memory 108 is depicted including boot-up process 118. In one or more implementations, the boot-up process 118 is accessed from the chipset attached memory 108, e.g., by the chipset attached memory controller 116. In at least one variation, the boot-up process 118 is accessed from the chipset attached memory 108 to boot-up the system 100, which includes, for instance, initializing one or more hardware components (e.g., the processing unit 112), loading an operating system (e.g., on the processing unit 112), and loading one or more applications (e.g., on the processing unit 112). In other words, the boot-up process 118 is accessed from the chipset attached memory 108 to return the system 100 to a working state (e.g., G0/SO state as specified by Advanced Configuration and Power Interface (ACPI)).

In accordance with the described techniques, booting up the system 100 using the boot-up process 118 from the chipset attached memory 108 enables applications to be loaded (e.g., into the processing unit 112) for debugging, testing, and logging problems with the system memory 104. By way of example and not limitation, such applications include debugging applications and logging tools. Here, such applications are illustrated as memory testing applications 120. The memory testing applications 120 are operable to perform one or more tests on the system memory 104 and to report results of those tests, e.g., by presenting them via a user interface and/or incorporating them into a file. In at least one variation, one or more of the memory testing applications 120 are executed by the processing unit 112 and using the chipset attached memory 108, e.g., as the main memory. This allows the system memory 104 to be directly tested while the system 100 operates from the chipset attached memory 108. As a result, the chipset attached memory 108 enables the system memory 104 to be tested by a system (i.e., system 100) which is not reliant on the system memory 104 to operate properly. Instead, the system 100 relies on the chipset attached memory 108 for proper operation while testing the system memory 104.

In at least one variation, booting up the system 100 using the boot-up process 118 from the chipset attached memory 108 also enables applications (not shown) to be loaded for debugging, testing, and logging problems with other components of the system 100, such as components that the system memory 104 relies on to operate properly and/or that are used for debugging and testing the system memory 104. Additionally, booting up the system 100 using the boot-up process 118 from the chipset attached memory 108 initializes various components of the system 100 and/or otherwise accessible to the system 100. Examples of such components include, but are not limited to, the components depicted in the illustrated examples, intellectual property (IP) blocks, graphics cards, data fabric, and cores, to name just a few.

The system 100 is implementable in any of a variety of different types of computing devices. For example, the system 100 is implementable in a device or apparatus such as personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, and an automotive computer, to name just a few.

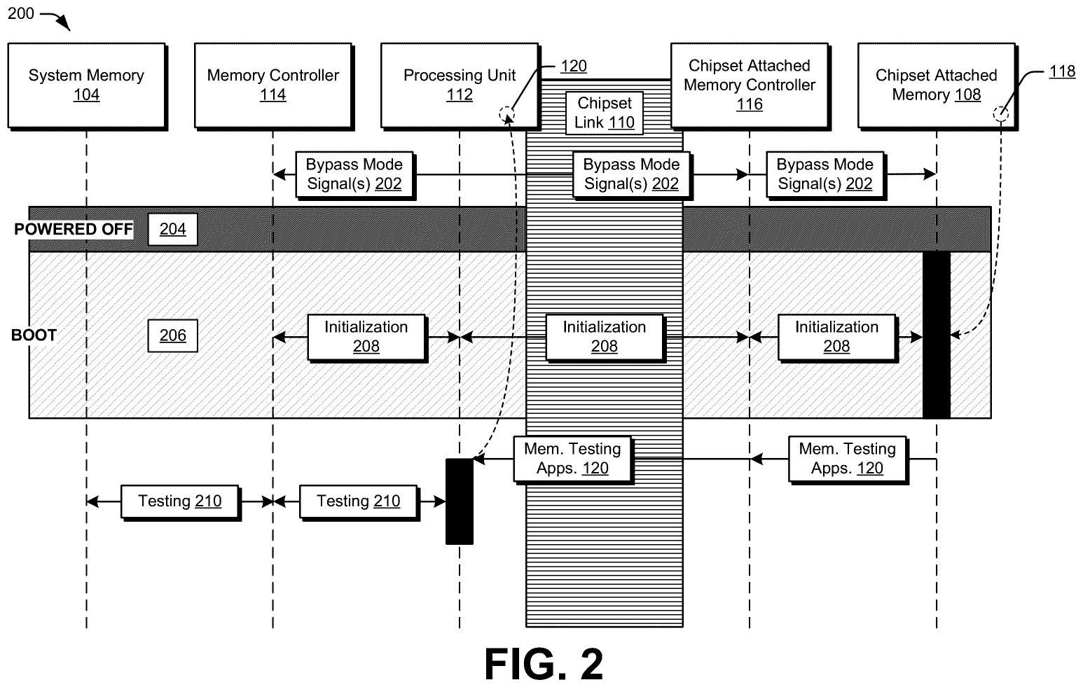

FIG. 2 depicts a non-limiting example 200 in which a system is booted up from a chipset attached memory to test a system memory. The example 200 includes the system memory 104, the memory controller 114, the processing unit 112, the chipset link 110, the chipset attached memory controller 116, and the chipset attached memory 108.

The example 200 includes a variety of example communications and operations between the system memory 104, the memory controller 114, the processing unit 112, the chipset link 110, the chipset attached memory controller 116, and the chipset attached memory 108 over time. In this example 200, the communications and operations are positioned vertically based on time, such that communications and operations closer to a top of the example occur prior to communications or operations further from the top of the example. It follows also that communications or operations closer to a bottom of the example occur subsequent to communications or operations further from the bottom. The example 200 also depicts various phases and/or states of the system 100 or portions of the system 100. These phases and/or states are also positioned in the example 200 vertically based on time, such that phases or states closer to a top of the example occur prior to phases, states, or communications further from the top.

The illustrated example 200 includes bypass mode signal(s) 202. In one or more implementations, the system 100 enters a “bypass mode” in order to bypass the system memory 104 and instead use the chipset attached memory 108 as the main memory. The system “bypasses” the system memory 104, for instance, by booting up from the chipset attached memory 108 rather than booting up from the system memory 104. Here, the bypass mode signal(s) 202 are depicted being transmitted from the processing unit 112 to the memory controller 114 and from the processing unit 112 to the chipset attached memory controller 116 and further to the chipset attached memory 108. It is to be appreciated, however, that in variations one or more of the bypass mode signal(s) 202 originate from any of the other components of the system 100 and/or are transmitted to any of the various components of the system 100.

Additionally or alternatively, the bypass mode signal(s) 202 are based on user input or interaction, such as user input received via a user interface indicating to switch the system to a bypass mode or interaction of a user with a mechanical mechanism (e.g., a toggle, button, switch, or dial) to switch the system to the bypass mode. In one or more implementations, the other illustrated phases or states of the system 100 and the communications occur while the system 100 and/or one or more components of the system are in the bypass mode. In at least one implementation, the bypass mode signal(s) 202 are initiated while the system 100 is powered off, e.g., toggling a physical switch. However, it at least one other variation the bypass mode signal(s) 202 are triggered while the system 100 is powered up, e.g., based on user input to a user interface.

Although not depicted, in one or more scenarios, the system switches out of the bypass mode (e.g., to a non-bypass mode) at some point in time subsequent to operating in the bypass mode. While operating in the non-bypass mode, the system 100 uses the system memory 104 as the main memory, such as by booting up the system from the system memory 104, loading an operating system and/or applications from the system memory 104, and so on. Alternatively or additionally, the system 100 operates in a non-bypass mode prior to switching to the bypass mode, e.g., prior to transmission of the bypass mode signal(s) 202.

In the bypass mode, though, the system 100 boots up from the chipset attached memory 108 rather than from the system memory 104. Here, the illustrated example 200 depicts a powered off phase 204 and a boot phase 206 of the system 100. During the powered off phase 204, the system 100 is powered down, examples of which include a soft off (e.g., G2/S5 state as specified by ACPI) and a mechanical off (e.g., G3 state as specified by ACPI), which require a reboot to return to a working state (e.g., G0/SO state as specified by ACPI).

In accordance with the described techniques, the boot-up process 118 is loaded into the chipset attached memory 108. Further, the boot-up process 118 is accessed from the chipset attached memory 108 and controls boot-up of the system during the boot phase 206. During the boot phase 206, the system 100 performs various operations according to the boot-up process 118, such as initialization 208, e.g., of hardware, firmware, and so on. In at least one implementation, the boot-up process 118 initiates loading an operating system (not shown), e.g., into the processing unit 112. After the operating system is loaded, in one or more implementations, control of the system is handed off from the boot-up process 118 to the operating system. In the illustrated example 200, execution of the boot-up process 118 from the chipset attached memory 108 is depicted by the solid black bar disposed along the dashed line extending from the chipset attached memory 108.

In accordance with the described techniques, the memory testing applications 120 (referred to in some figures as “mem. testing apps. 120) are also loaded from the chipset attached memory 108, e.g., into the processing unit 112. As noted above, the memory testing applications 120 include but are not limited to debugging applications and logging tools. It is to be appreciated that in variations, the memory testing applications 120 include different applications, tools, and/or monitors without departing from the spirit or scope of the described techniques.

After the memory testing applications 120 are loaded, the system 100 uses the loaded memory testing applications 120 to perform testing 210 of at least one of the system memory 104 or the memory controller 114. In one or more implementations, the testing 210 includes transmitting one or more signals to the system memory 104 and/or the memory controller 114, such as memory read/write requests and/or memory training operations (e.g., shmoos), and receiving responses to the tests. In at least one variation, the processing unit 112 executes the memory testing applications 120 to perform the testing 210, and the memory testing applications 120 provide outputs indictive of the testing. For example, one or more of the memory testing applications 120 outputs one or more of the tests performed during the testing 210, bugs and/or problems identified in association with the system memory 104 during the testing 210, recommendations for fixing identified buys and/or problems, other information associated with identified bugs and/or problems (e.g., problem type, error thrown, etc.), and so on. In the illustrated example 200, the testing 210 of the system memory 104 by the memory testing applications 120, loaded from the chipset attached memory 108, is depicted by the solid black bar disposed along the dashed line extending from the processing unit 112. In one or more variations, the testing 210 is performed over multiple periods of time, e.g., rather than over a continuous period of time as depicted in this example.

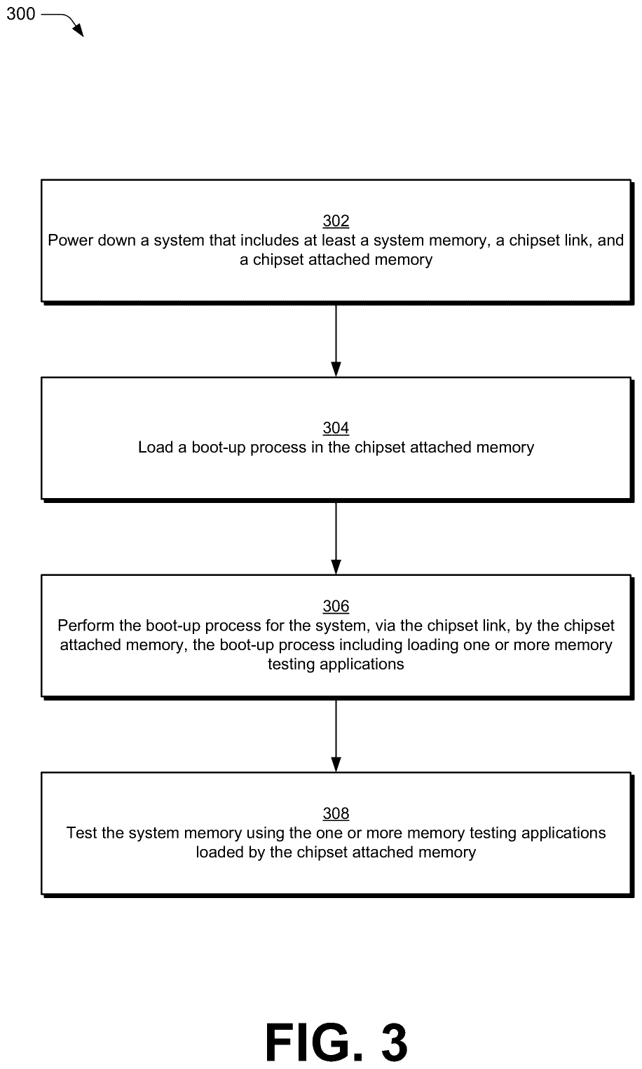

FIG. 3 depicts a procedure in an example 300 implementation of boot-up and memory testing with chipset attached memory.

A system that includes at least a system memory, a chipset link, and a chipset attached memory is powered down (block 302). By way of example, the system 100 which includes system memory 104, chipset link 110, and chipset attached memory 108 is powered down, examples of which include a soft off (e.g., G2/S5 state as specified by ACPI) and a mechanical off (e.g., G3 state as specified by ACPI), which require a reboot to return to a working state (e.g., G0/SO state as specified by ACPI).

A boot-up process is loaded in the chipset attached memory (block 304), and the boot-up process is performed for the system, via the chipset link, by the chipset attached memory (block 306). In accordance with the principles discussed herein, the boot-up process enables one or more memory testing applications to be loaded for testing the system memory. By way of example, the boot-up process 118 is loaded into the chipset attached memory 108. Further, the boot-up process 118 is accessed from the chipset attached memory 108 and controls boot-up of the system during the boot phase 206. During the boot phase 206, the system 100 performs various operations according to the boot-up process 118, such as initialization 208, e.g., of hardware, firmware, and so on. In at least one implementation, the boot-up process 118 initiates loading an operating system (not shown), e.g., into the processing unit 112. After the operating system is loaded, in one or more implementations, control of the system is handed off from the boot-up process 118 to the operating system. In the illustrated example 200, execution of the boot-up process 118 from the chipset attached memory 108 is depicted by the solid black bar disposed along the dashed line extending from the chipset attached memory 108. In accordance with the described techniques, the memory testing applications 120 (referred to in some figures as “mem. testing apps. 120) are also loaded from the chipset attached memory 108, e.g., into the processing unit 112. As noted above, the memory testing applications 120 include but are not limited to debugging applications and logging tools. It is to be appreciated that in variations, the memory testing applications 120 include different applications, tools, and/or monitors without departing from the spirit or scope of the described techniques.

The boot-up process is performed for the system, via the chipset link, by the chipset attached memory (block 308). By way of example, after the memory testing applications 120 are loaded, the system 100 uses the loaded memory testing applications 120 to perform testing 210 of at least one of the system memory 104 or the memory controller 114. In one or more implementations, the testing 210 includes transmitting one or more signals to the system memory 104 and/or the memory controller 114, such as memory read/write requests and/or memory training operations (e.g., shmoos), and receiving responses to the tests. In at least one variation, the processing unit 112 executes the memory testing applications 120 to perform the testing 210, and the memory testing applications 120 provide outputs indictive of the testing. For example, one or more of the memory testing applications 120 outputs one or more of the tests performed during the testing 210, bugs and/or problems identified in association with the system memory 104 during the testing 210, recommendations for fixing identified buys and/or problems, other information associated with identified bugs and/or problems (e.g., problem type, error thrown, etc.), and so on. In the illustrated example 200, the testing 210 of the system memory 104 by the memory testing applications 120, loaded from the chipset attached memory 108, is depicted by the solid black bar disposed along the dashed line extending from the processing unit 112. In one or more variations, the testing 210 is performed over multiple periods of time, e.g., rather than over a continuous period of time as depicted in this example.

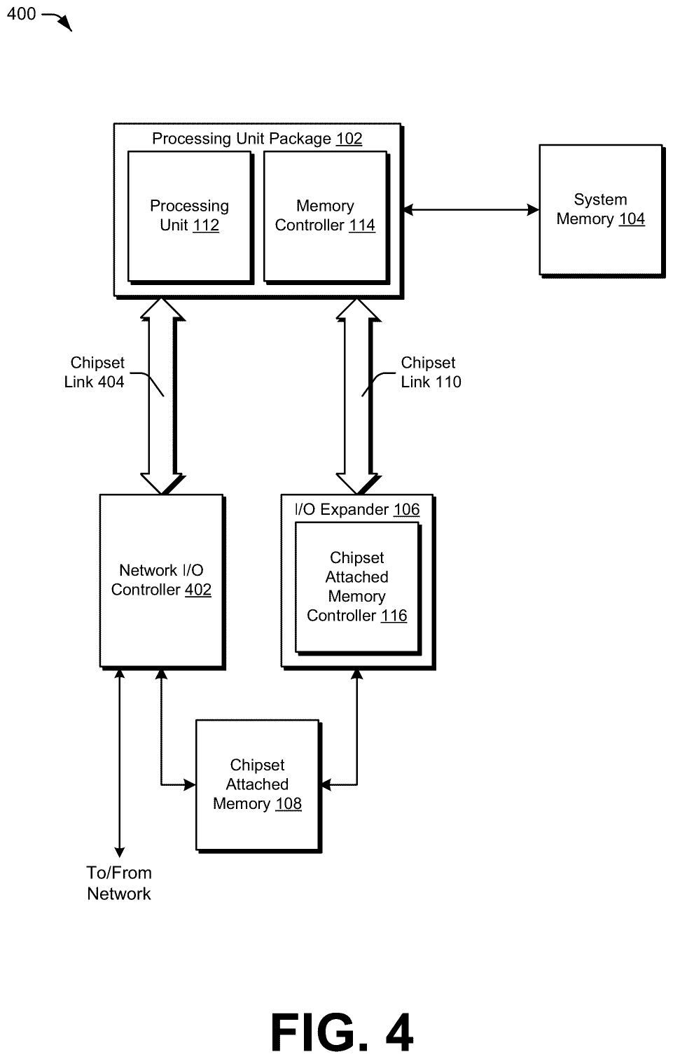

FIG. 4 is an illustration of another non-limiting example system 400 that employs a chipset attached memory for boot-up and testing a system memory. The system 400 includes the processing unit package 102, the system memory 104, the I/O expander 106, the chipset attached memory 108, and the chipset link 110 analogous to the system 100 of FIG. 1. The system 400 also includes a network I/O controller 402 and a chipset link 404 allowing the processing unit package 102 to communicate with the network I/O controller 402 using any of a variety of communication links analogous to chipset link 110.

The processing unit package 102, the system memory 104, the I/O expander 106, the chipset attached memory 108, the chipset link 110, the network I/O controller 402, and the chipset link 404 are installed on or are part of, for example, a motherboard or other printed circuit board. In one or more implementations, the I/O expander 106 (including the chipset attached memory controller 116), the chipset link 110, the chipset link 404, one or more memory channels between the processing unit package 102 and the system memory 104, and one or more memory channels between the I/O expander 106 and the chipset attached memory 108 are also referred to as a chipset of a motherboard or other printed circuit board.

The processing unit package 102 includes the processing unit 112 and the memory controller 114. Although a single processing unit 112 is illustrated in the system 400, the processing unit package 102 optionally includes any number of processing units of the same or different types, and or other types of components, such as an artificial intelligence accelerator. Given this architecture, such other optional components also access the system memory 104 directly (e.g., via the memory controller 114) or through an operating system running on the processing unit 112. Those components are also configured to access the chipset attached memory 108 (e.g., via the I/O expander 106 or the network I/O controller 402).

The network I/O controller 402 manages communication over a network, such as by sending data or control signals to one or more other devices via the network and receiving data or control signals from one or more other devices via the network. The network is implemented in any of a variety of manners, such as an Ethernet network, an InfiniBand network, and so forth. The network I/O controller 402 is also coupled or attached to the chipset attached memory 108 via one or more memory channels. In one or more implementations, the chipset attached memory 108 is address space (e.g., PCIe address space) that is addressable by other server nodes as well as components of the system 400 (e.g., the processing unit 112). The network I/O controller 402 is thus able to send read and write requests to the chipset attached memory 108 and receive responses from the chipset attached memory 108, analogous to the chipset attached memory controller 116.

In one or more implementations the chipset attached memory 108 is attached or coupled to only one of the network I/O controller 402 or the I/O expander 106 rather than attached or coupled to both the network I/O controller 402 and the I/O expander 106.

The network I/O controller 402 being attached or coupled to the chipset attached memory 108 supports various different usage scenarios. In one or more implementations, the processing unit package 102 is able to access the chipset attached memory 108 via the network I/O controller 402, allowing the chipset attached memory 108 to be used in situations where the chipset attached memory 108 is not attached or coupled to the I/O expander 106. Such situations arise, for example, where board routing limitations prevent the chipset attached memory 108 from being attached or coupled to the I/O expander 106.

In one or more implementations, the network I/O controller 402 allows the chipset attached memory 108 to be accessed by other devices via the network. This access is allowed using any of a variety of public or proprietary remote direct memory access (RDMA) techniques. For example, assume the system 400 is implemented in a server node connected to multiple other server nodes (e.g., some including their own chipset attached memory and optionally others not including their own chipset attached memory). Another server node communicates read and write requests to the chipset attached memory 108 via the network I/O controller 402 and receives responses from the chipset attached memory 108 via the network I/O controller 402. The other server node is thus able to make use of the chipset attached memory 108 without disrupting the system memory 104 or even the processing unit package 102. E.g., the processing unit package 102 need not have knowledge of the other server node accessing the chipset attached memory 108.

By way of another example, assume the system 400 is implemented in a server node connected to multiple other server nodes, at least one of which includes its own chipset attached memory. In at least one variation, the processing unit 112 (or other component of the processing unit package 102) is able to communicate read and write requests to the chipset attached memory of the other server node via the network I/O controller 402 and receive responses from the chipset attached memory of the other server node via the network I/O controller 402. The processing unit 112 or other component of the processing unit package 102 is thus able to make use of the chipset attached memory of another sever node without disrupting the system memory 104 or the chipset attached memory 108.

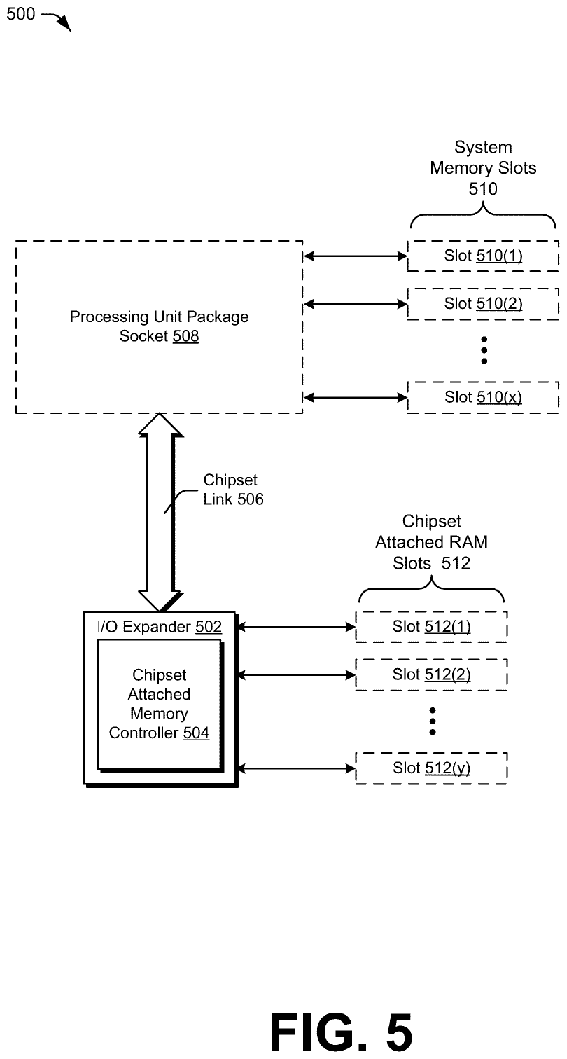

FIG. 5 is an illustration of another non-limiting example system 500 that employs a chipset attached memory for boot-up and testing a system memory. The system 500 is, for example, a motherboard or other printed circuit board. The system 500 includes an I/O expander 502 that includes a chipset attached memory controller 504, and a chipset link 506. The system 500 also includes a processing unit package socket 508, system memory slots 510, and chipset attached memory slots 512. The processing unit package socket 508 is designed to have a processing unit package, such as the processing unit package 102 of FIG. 1 or FIG. 4, installed or inserted therein. In one or more implementations, the I/O expander 502 (including the chipset attached memory controller 504), the chipset link 506, one or more memory channels between the processing unit package socket 508 and the system memory slots 510, and one or more memory channels between the I/O expander 502 and the chipset attached memory slots 512 are also referred to as a chipset of a motherboard or other printed circuit board.

The I/O expander 502 is an I/O expander analogous to the I/O expander 106 of FIG. 1 or FIG. 4. The chipset attached memory controller 504 is a chipset attached memory controller analogous to the chipset attached memory controller 116 of FIG. 1 or FIG. 4. The chipset link 506 is analogous to the chipset link 110 of FIG. 1 or FIG. 4.

The system memory slots 510 include multiple (“x”) memory slots 510(1), 510(2), . . . , 510(x). The system memory slots 510 are designed to have system memory, such as the system memory 104 of FIG. 1 or FIG. 4, installed or inserted therein. The system memory slots 510 are, for example, DIMM, SO-DIMM, or RDIMM slots. Although multiple memory slots 510(1), 510(2), . . . , 510(x) are illustrated, the system 500 optionally includes a single memory slot 510 or any other number of memory slots 510.

The chipset attached memory slots 512 include multiple (“y”) slots 512(1), 512(2), . . . , 512(y). The chipset attached memory slots 512 are designed to have chipset attached memory, such as the chipset attached memory 108 of FIG. 1 or FIG. 4, installed or inserted therein. The chipset attached memory slots 512 are, for example, DIMM, SO-DIMM, or RDIMM slots. Although multiple memory slots 512(1), 512(2), . . . , 512(y) are illustrated, the system 500 optionally includes a single memory slot 512 or any other number of memory slots 512.

With a processing unit package installed or inserted in the processing unit package socket 508, system memory installed or inserted in the system memory slots 510, chipset attached memory installed or inserted in the chipset attached memory slots 512, and additional I/O devices (e.g., a chipset attached nonvolatile memory and/or a chipset attached disk drive) optionally installed or otherwise coupled to the I/O expander 502, the system 500 becomes the system 100 of FIG. 1 or a system having tiered memory options.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the processing unit package 102, the system memory 104, the chipset attached memory 108, the chipset link 110, the processing unit 112, the memory controller 114, and the chipset attached memory controller 116) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. An apparatus comprising:
a system memory;
a chipset attached memory; and
a memory controller configured to:
power down the apparatus; and
load a boot-up process in the chipset attached memory, the boot-up process configured to perform the boot-up process for the apparatus by the chipset attached memory.

2. The apparatus of claim 1, wherein the boot-up process loads one or more memory testing applications.

3. The apparatus of claim 2, wherein the one or more memory testing applications are configured to test the system memory.

4. The apparatus of claim 3, wherein the one or more memory testing applications are further configured to report results of the testing by presenting the results of the testing on a user interface or incorporating the results of the testing into a file.

5. The apparatus of claim 1, wherein the boot-up process is further configured to initialize one or more hardware components of the apparatus.

6. The apparatus of claim 1, wherein the boot-up process is further configured to load an operating system.

7. The apparatus of claim 1, wherein the system memory comprises a main physical memory of the apparatus that is managed by an operating system.

8. The apparatus of claim 1, wherein the chipset attached memory is separate from the system memory.

9. The apparatus of claim 1, wherein the memory controller loads the boot-up process in the chipset attached memory when the apparatus is in a bypass mode, the bypass mode configured to bypass the system memory.

10. The apparatus of claim 1, wherein the memory controller is further configured to switch to a non-bypass mode after the boot-up process is complete, the non-bypass mode configured to use the system memory as a main memory.

11. A method comprising:
powering down a system that includes at least a system memory, a chipset link, and a chipset attached memory;
loading a boot-up process in the chipset attached memory;
performing the boot-up process for the system, via the chipset link, by the chipset attached memory, the boot-up process including loading one or more memory testing applications; and
testing the system memory using the one or more memory testing applications loaded by the chipset attached memory.

12. The method of claim 11, wherein the system memory comprises a main physical memory that is managed by an operating system of the system.

13. The method of claim 12, wherein the chipset attached memory is separate from the main physical memory.

14. The method of claim 11, wherein the one or more memory testing applications are configured to report results of the testing by presenting the results of the testing on a user interface or incorporating the results of the testing into a file.

15. The method of claim 11, wherein the boot-up process is further configured to initialize one or more hardware components of the system.

16. The method of claim 11, wherein the boot-up process is further configured to load an operating system.

17. The method of claim 11, wherein the boot-up process is loaded in the chipset attached memory when the system is in a bypass mode, the bypass mode configured to bypass the system memory.

18. The method of claim 17, further comprising switching to a non-bypass mode after the boot-up process is complete, the non-bypass mode configured to use the system memory as a main memory.

19. A system comprising:
a system memory; and
a chipset attached memory configured to load a boot-up process when the system memory is in a bypass mode, the boot-up process configured to test the system memory in the bypass mode.

20. The system of claim 19, wherein the system memory comprising a main system memory and wherein the chipset attached memory is separate from the main system memory.
